(19) United States
(12) Patent Application Publication
(10) Pub. No.: US 2026/0023195 A1
(43) Pub. Date: Jan. 22, 2026

(54) WEATHER SENSOR ANOMALY DETERMINATION DEVICE, WEATHER SENSOR SYSTEM, WEATHER SENSOR ANOMALY DETERMINATION METHOD, AND ANOMALY DETERMINATION PROGRAM

(71) Applicant: OMRON CORPORATION, Kyoto-shi (JP)

(72) Inventors: Masahiro ITOH, Kyoto-shi (JP); Yusuke ARITAKE, Kyoto-shi (JP); Takashi MIURA, Kyoto-shi (JP); Tatsuya HIRAKAWA, Kyoto-shi (JP); Hideki CHUJO, Kyoto-shi (JP)

(73) Assignee: OMRON CORPORATION, Kyoto-shi (JP)

(21) Appl. No.: 19/241,533

(22) Filed: Jun. 18, 2025

(30) Foreign Application Priority Data
Jul. 18, 2024 (JP) 2024-115106

(51) Int. Cl. G01W 1/18; G01W 1/02

(52) U.S. Cl. CPC G01W 1/18; G01W 1/02

(57) ABSTRACT

A cloud server 60 includes a data acquisition unit 61 and an anomaly determination unit 65. The data acquisition unit 61 acquires from the weather sensor module 1 weather data sensed by the weather sensor module 1 and anomaly determination data that determines whether or not there is an anomaly in the weather sensor module 1. The data acquisition unit 61 acquires weather data at a location where the weather sensor module 1 is installed from the external source. The anomaly determination unit 65 determines whether or not an anomaly can be eliminated to restore a normal state over time on the basis of whether any anomaly has been acquired by the data acquisition unit 61 for each of the multiple weather sensor modules 1 in a specific area in which the weather sensor modules 1 have been installed, and the weather data acquired by the data acquisition unit 61.

### CROSS-REFERENCE TO RELATED APPLICATIONS

This application claims priority to Japanese Patent Application No. 2024-115106 filed on Jul. 18, 2024. The entire disclosure of Japanese Patent Application No. 2024-115106 is hereby incorporated herein by reference.

### TECHNICAL FIELD

The present invention relates to a weather sensor anomaly determination device, a weather sensor system, a weather sensor anomaly determination method, and an anomaly determination program for determining whether or not an anomaly has occurred in a weather sensor.

### BACKGROUND ART

Weather sensors equipped with, for example, a wind sensor for sensing wind speed, wind direction, etc., a raindrop detection sensor for detecting rain, a temperature and humidity sensor for sensing temperature and humidity, and the like have been used in recent years.

These weather sensors are installed in a wide variety of regions, such as plains and mountainous areas, to sense weather data in each region, and transmit the data to a server device or the like over a communication line.

For instance, Patent Literature 1 discloses a remote monitoring system for a monitoring device including a weather sensor, which can confirm the on-site situation with high-resolution images in the event that an anomaly should occur, while also lowering communication costs and power consumption.

### CITATION LIST

### Patent Literature

Patent Literature 1: JP-A 2018-152642

### DISCLOSURE OF INVENTION

### Technical Problem

However, the following problem is encountered with the above conventional remote monitoring system.

For example, if an anomaly occurs in a raindrop detection sensor or the like of a weather sensor included in a monitoring device due to the buildup of snow or very heavy rain, the abnormal condition usually will be resolved over time, so there is no need to dispatch maintenance personnel to the installation site of the monitoring device. However, with the remote monitoring system disclosed in the above publication, whether or not maintenance is necessary cannot be determined simply by checking the image, and as a result, it becomes necessary to send out maintenance personnel.

It is an object of the present invention to provide a weather sensor anomaly determination device, a weather sensor system, a weather sensor anomaly determination method, and an anomaly determination program that can determine whether or not an anomaly is resolved over time and can be eliminated to restore a normal state.

### Technical Solution

The weather sensor anomaly determination device according to the first invention is a weather sensor anomaly determination device for determining whether or not an anomaly has occurred in a weather sensor, the weather sensor anomaly determination device comprising a data acquisition unit, an external data acquisition unit, and an anomaly determination unit. The data acquisition unit acquires from the weather sensor weather data sensed by the weather sensor and anomaly determination data that determines whether or not there is any anomaly in the weather sensor. The external data acquisition unit acquires weather data at a location where the weather sensor is installed from an external source. The anomaly determination unit determines whether or not an anomaly can be eliminated to restore a normal state over time on the basis of whether any anomaly has been acquired by the data acquisition unit for each of the multiple weather sensors in a specific area in which the weather sensors have been installed, and the weather data acquired by the external data acquisition unit.

Here, information about whether an anomaly has occurred is received from weather sensors installed in various locations, along with weather data from an external source that provides meteorological information, and a determination is made as to whether the anomaly is one that can return to a normal state over time, or one that requires maintenance.

Here, anomalies that can return to a normal state over time include, for example, anomalies that occur in a raindrop detection sensor, luminance sensor, or the like installed in a weather sensor due to snowfall, and anomalies that occur in a weather sensor due to very heavy rain.

A weather sensor is a device that is equipped with, for example, a wind sensor that senses wind speed, wind direction, etc., a raindrop detection sensor that detects rain, a temperature and humidity sensor that senses temperature and humidity, an luminance sensor, or the like.

The weather data acquired from the external source includes, for example, meteorological data such as precipitation, snowfall, lightning, and wind speed acquired from external services such as meteorological information management companies that provide weather data for each geographical region.

Consequently, even if a temporary anomaly should occur in a weather sensor due to snowfall or heavy rain, for example, it can be determined whether that anomaly is one that can be restored to a normal state over time, eliminating the need to dispatch maintenance personnel to the installation site.

As a result, it can be ascertained whether an anomaly sensed by a weather sensor is one that requires maintenance, so the need for dispatching maintenance personnel to the installation site can be kept to a minimum.

The weather sensor anomaly determination device according to the second invention is the weather sensor anomaly determination device according to the first invention, wherein the external data acquisition unit acquires snowfall information as the weather data.

This makes it possible to acquire snowfall data from the external source and compare it with snowfall information at the location of the weather sensor where the anomaly was sensed, and this means it can be determined whether or not the anomaly occurring in the weather sensor is an anomaly caused by snowfall and whether the anomaly will be able to return to a normal state as the snow melts over time.

The weather sensor anomaly determination device according to the third invention is the weather sensor anomaly determination device according to the second invention, wherein the anomaly determination unit uses the snowfall information acquired by the external data acquisition unit to determine whether or not there is any anomaly in the weather sensor that can be eliminated over time.

This means that snowfall information acquired from an external source, such as a meteorological information provider, can be used to determine whether an anomaly occurring in a weather sensor is one caused by snowfall and whether the anomaly can be restored to a normal state over time.

The weather sensor anomaly determination device according to the fourth invention is the weather sensor anomaly determination device according to the first or second invention, wherein the anomaly determination unit determines that the anomaly can be eliminated over time if the number of the weather sensors in the specific area for which it has been determined that an anomaly has occurred exceeds a specific threshold.

Consequently, if the number of weather sensors that detect an anomaly in a specified area exceeds a specified threshold, weather data acquired from the external source (snowfall information, etc.) can be checked to see if there has been any snowfall, heavy rain, or the like in the area, and it can be determined whether or not the anomaly is temporary and can be restored to a normal state.

The weather sensor anomaly determination device according to the fifth invention is the weather sensor anomaly determination device according to the first or second invention, wherein the anomaly determination data includes either no response, weather data exceeding an upper threshold or a lower threshold, or abnormal data.

Consequently, data indicating various kinds of anomaly that may occur in a weather sensor can be acquired to determine what kind of anomaly has occurred in the weather sensor.

The weather sensor anomaly determination device according to the sixth invention is the weather sensor anomaly determination device according to the first or second invention, wherein the specific area is preset so as to include a plurality of the weather sensors.

Consequently, whether or not anomalies in a plurality of weather sensors included in a specific area are anomalies that can be eliminated can be determined by setting the range of a city or town in a prefecture in advance as the specific are, for example.

The weather sensor anomaly determination device according to the seventh invention is the weather sensor anomaly determination device according to the first or second invention, wherein the specific area is set within a specific range of distance centered on a reference weather sensor that serves as a reference among the plurality of weather sensors.

Consequently, whether or not anomalies in a plurality of weather sensors within a range of a specified radius are anomalies that can be eliminated can be determined by using one of the weather sensors in which an anomaly has occurred as a reference, for example.

The weather sensor anomaly determination device according to the eighth invention is the weather sensor anomaly determination device according to the first or second invention, wherein the data acquisition unit acquires data about at least one of temperature, humidity, luminance, wind speed, wind direction, rainfall, and atmospheric pressure.

Consequently, when an anomaly occurs in one or more sets of weather data, it can be determined whether or not that anomaly can be eliminated.

The weather sensor anomaly determination device according to the ninth invention is the weather sensor anomaly determination device according to the first or second invention, further comprising a storage unit that stores weather data and anomaly determination data acquired by the data acquisition unit and the weather data acquired by the external data acquisition unit.

Consequently, the various kinds of data stored in the storage unit can be used determine whether or not an anomaly that has occurred in a weather sensor is one that can be eliminated.

The weather sensor anomaly determination device according to the tenth invention is the weather sensor anomaly determination device according to the first or second invention, further comprising a display unit that displays the determination result of the anomaly determination unit.

Consequently, the result of determining whether or not the anomaly that has occurred is one that can be eliminated can be displayed on a display unit such as a monitor of a PC (personal computer), for example.

The weather sensor anomaly determination device according to the eleventh invention is the weather sensor anomaly determination device according to the first or second invention, further comprising a notification unit that notifies a user on the basis of the determination result of the anomaly determination unit.

Consequently, a notification of the result of determining whether the anomaly that has occurred can be eliminated can be sent, for example, to the administrator's PC, mobile terminal, etc. Therefore, if the anomaly requires maintenance, the administrator can promptly dispatch maintenance personnel to the location where the weather sensor is installed.

The weather sensor system according to the twelfth invention comprises the weather sensor anomaly determination device according to the first or second invention; and a plurality of weather sensors.

Consequently, a system can be constructed that can ascertain whether or not a detected anomaly in a weather sensor is an anomaly that requires maintenance, which minimizes the need to dispatch maintenance personnel to the installation site.

The weather sensor anomaly determination method according to the thirteenth invention is an anomaly determination method for determining whether or not any anomaly has occurred in a weather sensor, comprising a data acquisition step, an external data acquisition step, and an anomaly determination step. The data acquisition step involves acquiring, from the weather sensor, weather data sensed by the weather sensor and anomaly determination data that determines whether or not there is any anomaly in the weather sensor. The external data acquisition step involves acquiring weather data from an external source at a location where the weather sensor is installed. The anomaly determination step involves determining whether or not an anomaly can be eliminated to restore a normal state over time on the basis of whether any anomaly has been acquired by the data acquisition unit for each of the multiple weather sensors in a specific area in which the weather sensors have been installed, and the weather data acquired by the external data acquisition unit.

Here, information about whether any anomalies have occurred is received from weather sensors installed in various locations, along with weather data from an external source that provides meteorological information, and it is determined whether an anomaly is one that can be restored to a normal state over time, or one that requires maintenance.

Here, anomalies that be restored to a normal state over time include, for example, anomalies that occur in a raindrop detection sensor, luminance sensor, or the like installed in a weather sensor due to snowfall, and anomalies that occur in a weather sensor due to very heavy rain.

A weather sensor is a device that is equipped with, for example, a wind sensor that senses wind speed, wind direction, etc., a raindrop detection sensor that detects rain, a temperature and humidity sensor that senses temperature and humidity, an luminance sensor, or the like.

The weather data acquired from the external source includes, for example, meteorological data such as precipitation, snowfall, lightning, and wind speed acquired from external services such as meteorological information management companies that provide weather data for each geographical region.

Consequently, even if a temporary anomaly should occur in a weather sensor due to snowfall or heavy rain, for example, it can be determined whether that anomaly is one that can be restored to a normal state over time, eliminating the need to dispatch maintenance personnel to the installation site.

As a result, it can be ascertained whether an anomaly sensed by a weather sensor is one that requires maintenance, so the need for dispatching maintenance personnel to the installation site can be kept to a minimum.

The weather sensor anomaly determination program according to the fourteenth invention is an anomaly determination program that determines whether or not an anomaly has occurred in a weather sensor, the anomaly determination program causing a computer to execute a weather sensor anomaly determination method comprising a data acquisition step, an external data acquisition step, and an anomaly determination step. The data acquisition step involves acquiring, from the weather sensor, weather data sensed by the weather sensor and anomaly determination data that determines whether or not there is any anomaly in the weather sensor. The external data acquisition step involves acquiring weather data from an external source at a location where the weather sensor is installed. The anomaly determination step involves determining whether or not an anomaly can be eliminated to restore a normal state over time on the basis of whether any anomaly has been acquired by the data acquisition unit for each of the multiple weather sensors in a specific area in which the weather sensors have been installed, and the weather data acquired by the external data acquisition unit.

Here, information about whether an anomaly has occurred is received from weather sensors installed in various locations, along with weather data from an external source that provides meteorological information, and a determination is made as to whether the anomaly is one that can return to a normal state over time, or one that requires maintenance.

Here, anomalies that can return to a normal state over time include, for example, anomalies that occur in a raindrop detection sensor, luminance sensor, or the like installed in a weather sensor due to snowfall, and anomalies that occur in a weather sensor due to very heavy rain.

A weather sensor is a device that is equipped with, for example, a wind sensor that senses wind speed, wind direction, etc., a raindrop detection sensor that detects rain, a temperature and humidity sensor that senses temperature and humidity, an luminance sensor, or the like.

The weather data acquired from the external source includes, for example, meteorological data such as precipitation, snowfall, lightning, and wind speed acquired from external services such as meteorological information management companies that provide weather data for each geographical region.

Consequently, even if a temporary anomaly should occur in a weather sensor due to snowfall or heavy rain, for example, it can be determined whether that anomaly is one that can be restored to a normal state over time, eliminating the need to dispatch maintenance personnel to the installation site.

As a result, it can be ascertained whether an anomaly sensed by a weather sensor is one that requires maintenance, so the need for dispatching maintenance personnel to the installation site can be kept to a minimum.

### Effects

With the weather sensor anomaly determination device of the present invention, it is possible to determine whether an anomaly will be eliminated over time, and whether the anomaly can be restored to a normal state.

### BRIEF DESCRIPTION OF DRAWINGS

FIG. 1 is a control block diagram of the configuration of a weather sensor system including a plurality of weather sensors according to an embodiment of the present invention;

FIG. 2 is an oblique view of the configuration of a weather sensor included in the weather sensor system of FIG. 1;

FIG. 3 is a side view of the weather sensor of FIG. 2;

FIG. 4 is a top view of the weather sensor of FIG. 2;

FIG. 5 is a cross-sectional view of the configuration of the upper part of the weather sensor in the cross-sectional view along the A-A line in FIG. 4;

FIG. 6 is a table showing sensor data sensed by various sensors included in the sensor unit of the weather sensor module of FIG. 5, the weather sensor module IDs, and detection times;

FIG. 7 is a table showing the installation location (latitude, longitude, altitude, installation location information, area ID) of the weather sensor module in FIG. 5;

FIG. 8 is a diagram showing map information indicating the installation locations of weather sensor modules and whether there are any anomalies;

FIG. 9 is a diagram showing map information indicating the installation locations of weather sensor modules and the fact that anomalies have been restored to a normal state over time;

FIG. 10 is a diagram showing AMeDAS data received from an external service for the area in which weather sensor modules have been installed;

FIG. 11 is a table showing a state in which an error (anomaly) has occurred in a rainfall sensor included in one of the weather sensor modules that sensed the sensor data shown in FIG. 6;

FIG. 12 is a table showing a state in which an error (anomaly) has occurred in a rainfall sensor included in a weather sensor module installed in the same area as the weather sensor modules that sensed the sensor data shown in FIG. 6;

FIG. 13 is a table showing error code IDs and summaries of the errors shown in FIGS. 11 and 12;

FIG. 14A is a table showing sensor data when an anomaly has occurred in a single weather sensor module, and FIG. 14B is a table showing sensor data when an anomaly has occurred in a plurality of weather sensor modules in an area;

FIG. 15 is a flowchart showing the processing flow in the weather sensor anomaly determination method of this embodiment;

FIG. 16 is a control block diagram of the configuration of a weather sensor system according to yet another embodiment of the present invention;

FIG. 17A is a table showing the monitoring area radius, anomaly determination coefficient, and area anomaly determination threshold for the area in which a plurality of weather sensor modules included in the weather sensor system of FIG. 16 have been installed, and FIG. 17B is an area table including area IDs, area states, weather sensor module states, and weather sensor IDs of errors;

FIG. 18 is a flowchart showing the processing flow of a weather sensor anomaly determination method used in the weather sensor system of FIG. 16;

FIG. 19 is a diagram showing area settings for a specific radial distance centered on weather sensor modules in which a reference anomaly has occurred; and

FIG. 20 is a diagram showing that the weather sensor modules in which the anomaly shown in FIG. 19 has occurred have been restored to a normal state over time.

### BEST MODE FOR CARRYING OUT THE INVENTION

### Embodiment 1

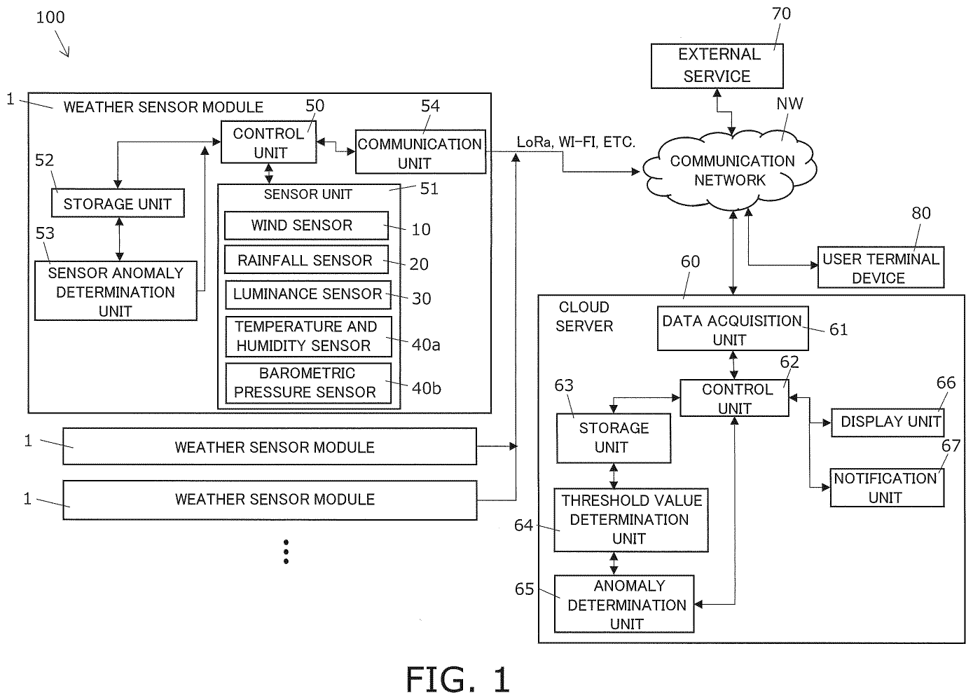

A cloud server (weather sensor anomaly determination device) 60 that performs anomaly determination for weather sensor modules (weather sensors) 1 according to an embodiment of the present invention, and a weather sensor system 100 equipped with the same will now be described with reference to FIGS. 1 to 15.

In this embodiment, some unnecessarily detailed description may be omitted. For example, detailed description of already known facts or redundant description of components that are substantially the same may be omitted. This is to avoid unnecessary repetition in the following description, and facilitate an understanding on the part of a person skilled in the art.

The applicant has provided the appended drawings and the following description so that a person skilled in the art might fully understand this disclosure, but does not intend for these to limit what is discussed in the patent claims.

### (1) Configuration of Weather Sensor System 100

As shown in FIG. 1, the weather sensor system 100 of this embodiment is provided with a plurality of weather sensor modules (weather sensors) 1 that are connected together via a communication network NW, a cloud server (weather sensor anomaly determination device) 60 that determines whether or not an anomaly has occurred in any of the weather sensor modules 1, an external service 70, and a user terminal device 80.

The weather sensor modules 1 are set in each geographical region as devices for sensing meteorological information for that region, and sense meteorological data such as rainfall, wind (wind speed, wind direction), temperature, humidity, and barometric pressure.

The detailed configuration of the weather sensor module 1 will be described below.

The cloud server 60 receives and stores the weather data for each region received from the weather sensor modules 1 via the communication network NW, the determination results for whether there are any anomalies in the weather sensor modules 1, and so forth. Also, the cloud server 60 uses the meteorological information for each region received from the external service 70 to determine whether or not an anomaly in a weather sensor module 1 determined to have an anomaly can be restored to a normal state over time.

The configuration of the cloud server will be described in detail below.

The external service 70 is a meteorological information provider that provides meteorological information for each geographical region, and provides various kinds of information to the outside, such as temperature, humidity, wind speed, wind direction, rainfall, snowfall, typhoons, linear precipitation bands, lightning, pollen, PM2.5 levels, and wave height.

The user terminal device 80 is, for example, a PC (personal computer), smartphone, tablet terminal, or the like that is owned by an administrator who manages the weather sensor modules 1, and receives and displays the results of anomaly determination for the weather sensor modules 1 in the cloud server 60.

### (2) Configuration of Weather Sensor Module 1

The weather sensor module 1 in this embodiment is, for example, a device that is installed outdoors and measures rain, wind, luminance, temperature, humidity, barometric pressure, etc., and as shown in FIG. 1, is equipped with a control unit 50, a sensor unit 51, a storage unit 52, a sensor anomaly determination unit 53, and a communication unit 54.

The control unit 50 is constituted by a CPU (central processing unit) and other circuits, and is connected to and controls the sensor unit 51, the storage unit 52, the sensor anomaly determination unit 53, and the communication unit 54.

The sensor unit 51 senses meteorological data such as wind speed, wind direction, rainfall, luminance, temperature, humidity, and barometric pressure, and converts the various meteorological data into signals. The sensor unit 51 has a wind sensor 10, a rainfall sensor 20, an luminance sensor 30, a temperature and humidity sensor 40a, and an barometric pressure sensor 40b, which will be discussed below.

The storage unit 52 stores weather data sensed by the sensors included in the sensor unit 51, the determination result for the sensor anomaly determination unit 53, and the like.

The sensor anomaly determination unit 53 determines whether or not there is an anomaly inside the weather sensor module 1, such as a disconnection or other such malfunction that requires maintenance, that makes it impossible to send or receive weather data, such as whether or not there is an anomaly that makes it impossible to sense weather data because snow has accumulated and covered the sensing area of the weather sensor module 1. More specifically, the sensor anomaly determination unit 53 determines whether or not there is an anomaly depending on, for example, whether or not the number of weather sensor modules 1 determined to have an anomaly in a specified area is at or above a specific threshold.

The communication unit 54 receives various kinds of data from the control unit 50 and transmits this data to the cloud server 60 or the like via a communication line such as LoRa (Long Range) or Wi-Fi (registered trademark) and the communication network NW.

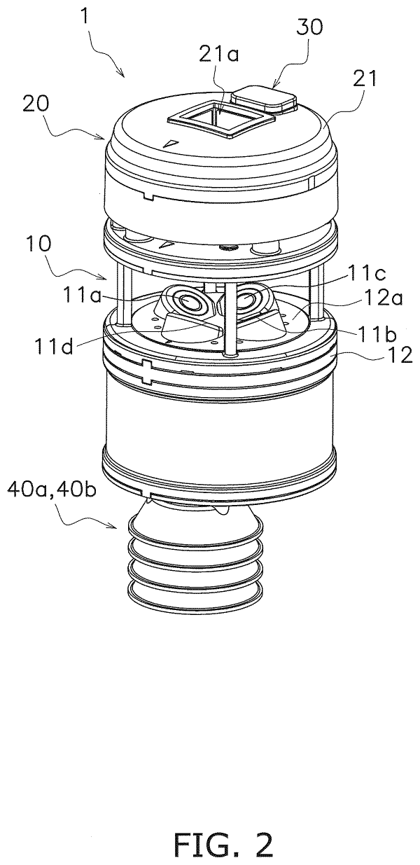

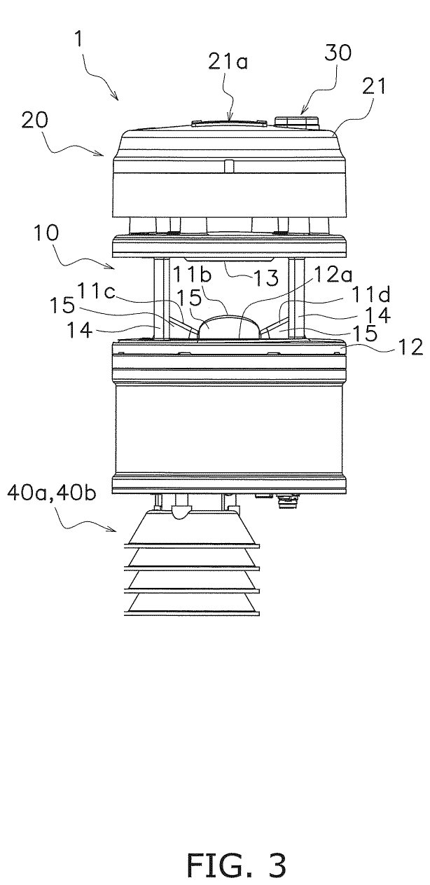

The structure of the weather sensor module 1 here will now be described with reference to FIGS. 2 and 3. As shown in FIGS. 2 and 3, the weather sensor module 1 includes a wind sensor 10, a rainfall sensor 20, an luminance sensor 30, a temperature and humidity sensor 40a, and an barometric pressure sensor 40b.

As shown in FIGS. 2 and 3, the wind sensor 10 is provided in the middle part of the weather sensor module 1 and measures the speed and direction of wind passing through the gaps between the rainfall sensor 20 and the temperature and humidity sensor 40a and the barometric pressure sensor 40b.

More specifically, the wind sensor 10 includes ultrasonic sensors 11a, 11b, 11c, and 11d, post members 14, and a base portion 15, as shown in FIGS. 2 and 3.

The ultrasonic sensors 11a, 11b, 11c, and 11d are disposed on the upper surface 12a of a base 12, as shown in FIG. 2, etc.

The ultrasonic sensors 11a, 11b, 11c, and 11d are used in pairs (the ultrasonic sensors 11a and 11b and the ultrasonic sensors 11c and 11d) that are disposed opposite each other. One pair of ultrasonic sensors 11a and 11b functions as an emitter that emits ultrasonic waves, and the other functions as a receiver that receives ultrasonic waves. These functions can also be switched around.

For instance, when the ultrasonic sensor 11a emits a ultrasonic wave, the ultrasonic sensor 11b disposed opposite the ultrasonic sensor 11a receives the ultrasonic wave emitted from the ultrasonic sensor 11a and reflected by the reflective surface 13 shown in FIG. 3. The same applies when the ultrasonic sensors 11b, 11c, and 11d emit ultrasonic waves.

A wind sensor control unit (not shown) measures wind speed and wind direction in the gaps (measurement areas) between the rainfall sensor 20 and the temperature and humidity sensor 40a and the barometric pressure sensor 40b on the basis of the change in the reception timing of ultrasonic waves received by the ultrasonic sensors 11a, 11b, 11c, and 11d, which function as receiving units.

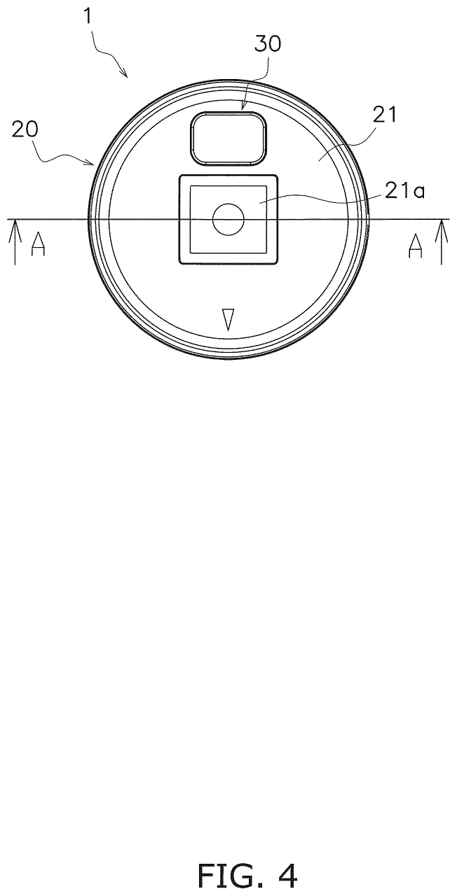

As shown in FIGS. 2 and 3, the rainfall sensor 20 is provided at the upper part of the weather sensor module 1, detects raindrops that pass through a specific opening 21a (see FIG. 4, etc.) provided on the top surface of the housing unit 21, and calculates the amount of rainfall by sensing the size of the detected raindrops and the amount per unit of time.

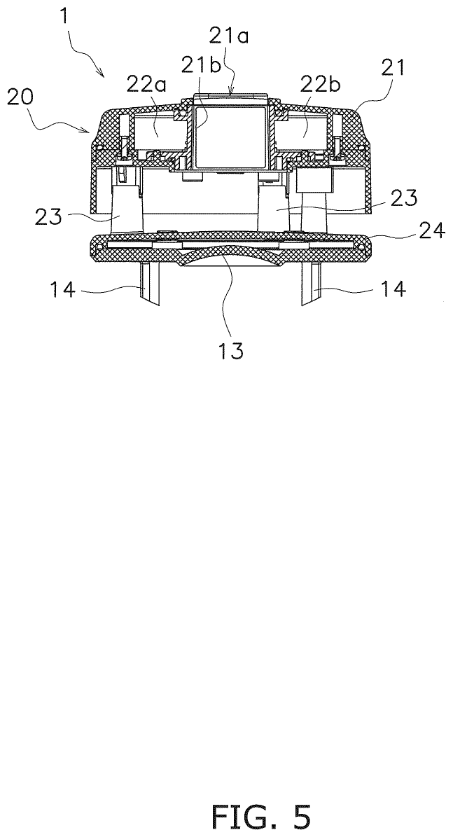

More precisely, the rainfall sensor 20 has a light source unit 22a and a light receiving unit 22b (see FIG. 5) inside the housing unit 21.

As shown in FIG. 5, the light source unit 22a and the light receiving unit 22b are disposed at positions opposite each other on the inner wall surface 21b of the opening 21a.

The light source unit 22a is, for example, an LED (light emitting diode), and emits infrared light toward the light receiving unit 22b via a collimating lens and a condenser lens (neither of which is shown).

The light receiving unit 22b is, for example, a photodiode, is disposed at a position opposite the light source unit 22a, and receives light condensed through a condenser lens (not shown).

Light is then emitted from the light source unit 22a to the raindrop detection area formed between the light source unit 22a and the light receiving unit 22b, and part of the light detected by the light receiving unit 22b is blocked by the raindrops, reducing the amount of light received by the light receiving unit 22b, thereby detecting the presence or absence of raindrops.

The rainfall sensor 20 also has a plurality of legs 23 provided on the upper surface of the base 24, and is linked to the wind sensor 10 that constitutes the middle part of the weather sensor module 1 via the legs 23 and the base.

As shown in FIGS. 2 and 3, the luminance sensor 30 is provided at the upper part of the weather sensor module 1 together with the rainfall sensor 20, and measures luminance as part of the meteorological information.

As shown in FIGS. 2 and 3, the temperature and humidity sensor 40a is provided at the lower part of the weather sensor module 1, and measures temperature (air temperature) and humidity as meteorological information.

As shown in FIGS. 2 and 3, the barometric pressure sensor 40b is provided at the lower part of the weather sensor module 1, and measures barometric pressure as meteorological information.

Since the weather sensor module 1 of this embodiment has the structure described above, there is the risk that anomalies may occur, such as snow accumulating in the gaps (such as on the ultrasonic sensors 11a, 11b, 11c, and 11d) between the rainfall sensor 20 and the temperature and humidity sensor 40a and the barometric pressure sensor 40b, making it impossible for the wind sensor 10 to measure wind, or snow falling into the opening 21a, making it impossible for the rainfall sensor 20 to detect rain. Similarly, if a linear precipitation band should occur and cause heavier rain than anticipated, there is the risk that anomalies will occur in the measurements of the sensors included in the sensor unit 51.

However, such anomalies caused by snowfall or heavy rain on the weather sensor module 1 will be resolved once the snow melts or the heavy rain lets up, and the weather sensor module 1 can then return to its normal state.

On the other hand, if flying debris such as fallen leaves should cover the opening 21a or the ultrasonic sensors 11a, 11b, 11c, and 11d, for example, it is unlikely that an anomaly in the sensor unit 51 will be resolved even after some time has passed, making it necessary to dispatch maintenance personnel to remove the fallen leaves, etc.

With the weather sensor system 100 of this embodiment, weather data (snowfall, heavy rain, etc.) received from an external service is used to determine whether or not an anomaly occurring in the weather sensor module 1 is one that can be restored to a normal state over time.

Consequently, if the anomaly is determined to be the result of snowfall or the like and does not require maintenance, it is possible to wait for time to pass until the normal state is restored, without having to dispatch maintenance personnel.

### (3) Cloud Server 60

With the weather sensor system 100 in this embodiment, as shown in FIG. 1, the cloud server 60 determines whether or not an anomaly that has occurred in a plurality of weather sensor modules 1 connected via a communication network NW is an anomaly that can be restored to a normal state over time.

More specifically, as shown in FIG. 1, the cloud server 60 includes a data acquisition unit (data acquisition unit, external data acquisition unit) 61, a control unit 62, a storage unit 63, a threshold determination unit 64, an anomaly determination unit 65, a display unit 66, and a notification unit 67.

The data acquisition unit (data acquisition unit, external data acquisition unit) 61 acquires, from the weather sensor module 1, weather data sensed by the weather sensor module 1 and anomaly determination data that determines the presence or absence of an anomaly in the weather sensor module 1. The data acquisition unit 61 acquires weather data for the location where the weather sensor module 1 is installed, from an external service 70. The data acquisition unit 61 also functions as an external data acquisition unit, and acquires snowfall information as weather data.

The anomaly determination data acquired by the data acquisition unit 61 includes, for example, either no response, weather data exceeding an upper or lower threshold, or abnormal data.

The control unit 62 is composed of a CPU (central processing unit) and other circuits, and is connected to and controls the data acquisition unit 61, the storage unit 63, the anomaly determination unit 65, the display unit 66, and the notification unit 67.

The storage unit 63 stores the weather data and anomaly determination data acquired by the data acquisition unit 61, and the weather data acquired by the data acquisition unit 61 from the external service 70.

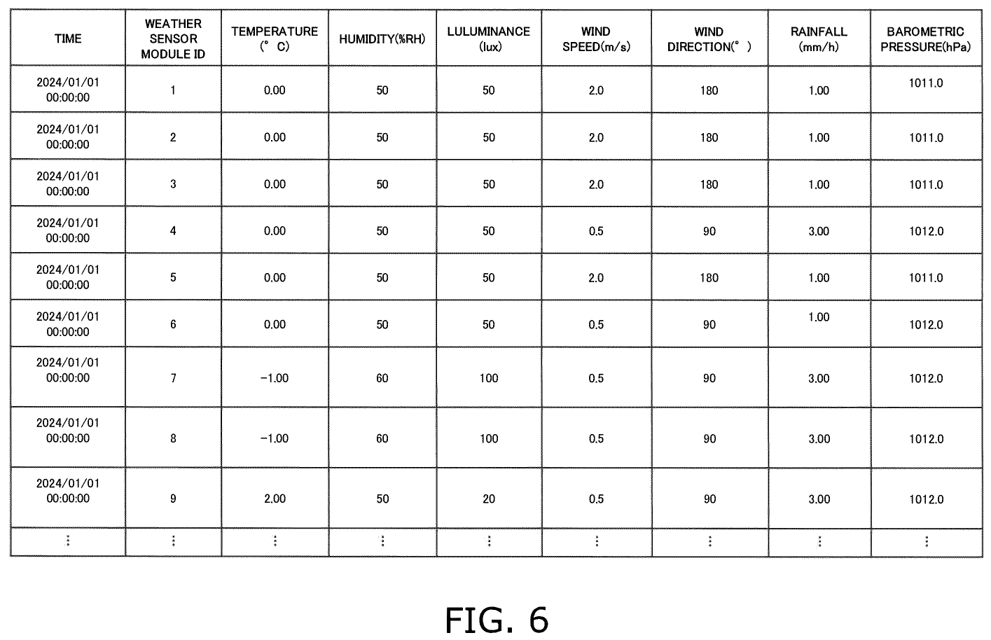

The weather data sensed by the weather sensor module 1 and stored in the storage unit 63 includes, for example, as shown in FIG. 6, the time of detection, the weather sensor module ID (identification) assigned to each of the multiple weather sensor modules 1, temperature (° C.), humidity (% RH), luminance (lux), wind speed (m/s), wind direction (°), rainfall (mm/h), and barometric pressure (hPa).

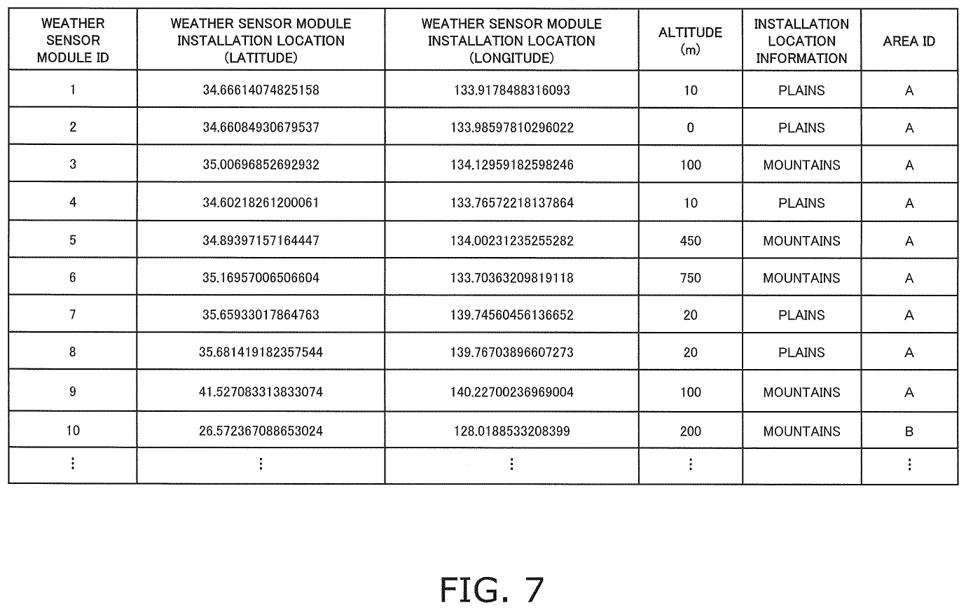

Also, as shown in FIG. 7, the storage unit 63 stores the installation location (latitude and longitude) for each of the weather sensor modules 1, altitude (m), installation location information (plains, mountains, etc.), and an area ID indicating in which area the module is installed among areas previously set as areas such as cities, towns, regions, etc.

The threshold determination unit 64 determines, for example, whether or not the number of weather sensor modules 1 determined to have an error in a specific area is at or above a specific threshold. The threshold determination unit 64 transmits the determination result of whether the number of weather sensor modules 1 determined to have an error is at or above the specific threshold to the anomaly determination unit 65 and the storage unit 63, and also transmits the result to each weather sensor module 1 via the communication network NW.

The anomaly determination unit 65 determines whether or not an anomaly exists for each weather sensor module 1 in a specified area in which a plurality of weather sensor modules 1 are installed, as acquired by the data acquisition unit 61, and whether or not the anomaly can be restored to a normal state over time on the basis of the weather data acquired by the data acquisition unit 61 from the external service 70.

In particular, the anomaly determination unit 65 uses the snowfall information acquired by the data acquisition unit 61 to determine whether or not the weather sensor module 1 is experiencing an anomaly that can be eliminated over time.

The anomaly determination unit 65 refers to weather data (information about snowfall, heavy rain, etc.) acquired from the external service 70, and if the number of weather sensor modules 1 determined to have experienced an anomaly in a specified area exceeds a specified threshold, this unit determines that these anomalies do not require any maintenance, and are instead anomalies caused by snowfall, etc., that can be eliminated over time.

The specific area subject to anomaly determination for a weather sensor module 1 is set in advance to include a plurality of weather sensor modules 1.

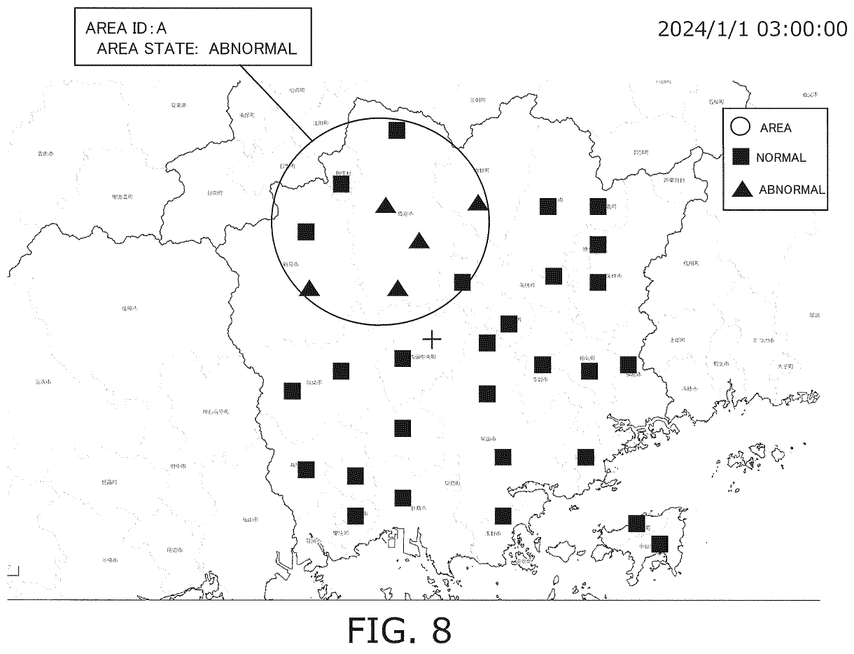

The specific area to be subjected to the anomaly determination is preset as a circular area (area ID: A) that includes nine weather sensor modules 1, as shown in FIG. 8, for example.

In the example shown in FIG. 8, the result of anomaly determination in the weather sensor system 100 of this embodiment is that of the nine weather sensor modules 1 included in area A, the five weather sensor modules 1 indicated by ▴ are determined to have an anomaly (the four weather sensor modules 1 indicated by ▪ are normal).

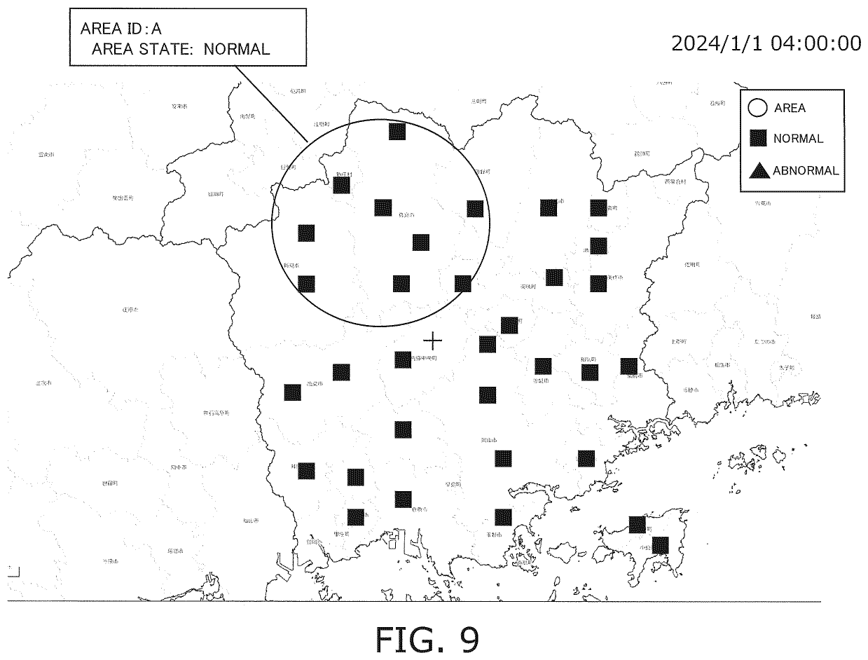

At this point, as shown in FIG. 8, even if the sensor units 51 (such as the rainfall sensor 20, etc.) of a plurality of weather sensor modules 1 (▴) that have been determined to be experiencing an anomaly within the specified area (area ID: A) are unable to sense due to snowfall or heavy rain, if the snow melts or the heavy rain stops, restoring a normal state (▪) over time, then the weather sensor modules 1 in that area (area ID: A) will be restored to their normal state, as shown in FIG. 9.

Consequently, the anomaly determination unit 65 can use meteorological information acquired from the external service 70 to determine that, for a plurality of weather sensor modules 1 in which an anomaly has been determined to have occurred within the area (area ID: A) shown in FIGS. 8 and 9, the anomaly is one that can be restored to a normal state over time, which allows the user to employ the option of waiting until a normal state is restored, without having to dispatch maintenance personnel.

The display unit 66 displays, as map information, the positions and so forth of the weather sensor modules 1 in which anomalies have occurred in the specific area shown in FIGS. 8 and 9 as a result of the determination by the anomaly determination unit 65. That is, the display unit 66 displays information (installation location, type of anomaly, etc.) of the weather sensor modules 1 in which anomalies have occurred and which require maintenance (or which do not require maintenance).

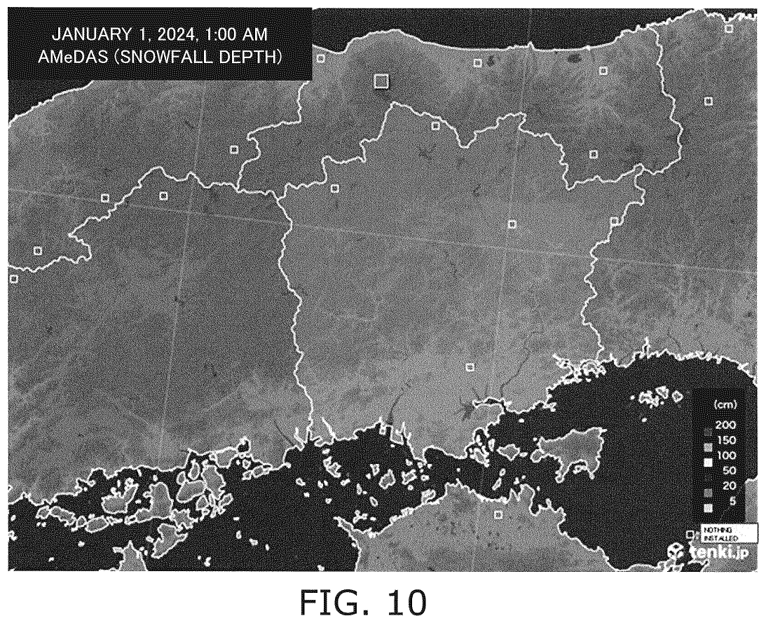

The weather data acquired by the data acquisition unit 61 from the external service 70 includes, for example, weather data for each region (such as snowfall, heavy rain, etc.) provided by the Automated Meteorological Data Acquisition System (AMeDAS) shown in FIG. 10, and weather data provided by various systems that provide other weather data.

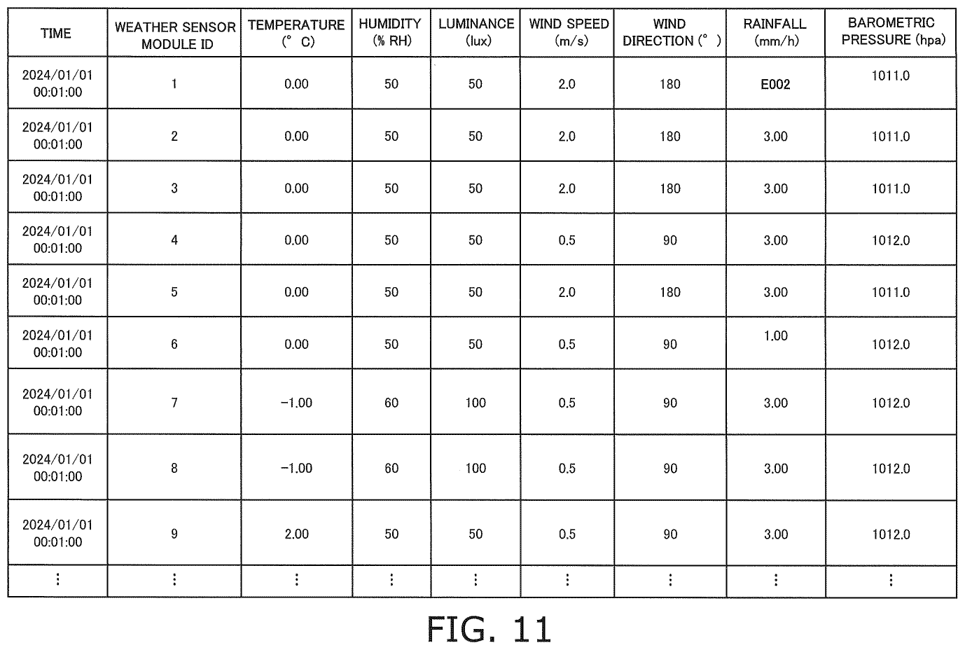

Here, when a weather sensor module 1 that has been determined to have an anomaly by the sensor anomaly determination unit 53 for each weather sensor module 1 and the anomaly determination unit 65 on the cloud server 60 side is an individual weather sensor module 1 (caused by a broken wire, IC failure, etc.), an error code (E002) is displayed in the rainfall (mm/h) box for the weather sensor module 1 with weather sensor module ID: 1, as shown in FIG. 11.

Regarding such individual anomalies in weather sensor modules 1, since no anomalies have occurred in weather sensor modules 1 installed nearby, the anomaly determination unit 65 determines that there is a high probability that the anomaly requires maintenance, without even having to refer to the weather data obtained from the external service 70.

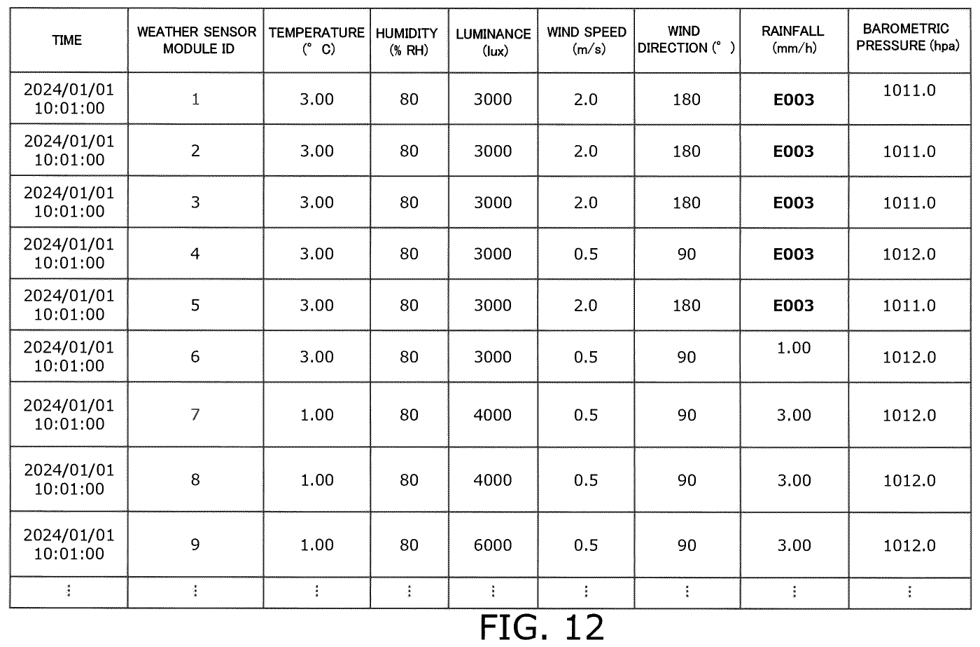

On the other hand, for example, if there is an anomaly in a plurality of weather sensor modules 1 in a specified area (area ID: A) (such as sensor data exceeding upper or lower thresholds), an error code (E003) is displayed in the rainfall (mm/h) box for five weather sensor modules 1 (weather sensor module IDs: 1 to 5) out of the nine weather sensor modules 1 in the area, as shown in FIG. 12.

If an anomaly thus occurs in a plurality of weather sensor modules 1 within the area, the anomaly determination unit 65 refers to actual weather data within that area (snowfall, heavy rain, etc.), and to whether the number of weather sensor modules 1 in which an anomaly has occurred is at or above a specific threshold (5), to determine whether or not the anomaly is one that can be restored to a normal state over time.

More specifically, the anomaly determination unit 65 uses the following calculation formula (1) to determine whether a weather sensor module 1 is in a normal or abnormal state (sensor anomaly, area anomaly).

$$F = ( number of erroneous weather sensor modules in the area ) \text{} \text{/} \text{} ( number of all the weather sensor modules in the area ) \times correction coefficient \times 100 \qquad ( 1 )$$

The correction coefficient is a coefficient for preventing the F value from becoming extremely large when the number of weather sensor modules 1 installed in the monitoring area is small.

As a result, when F=0, the anomaly determination unit 65 determines that the weather sensor module 1 is normal.

Also, when 0<F<area anomaly determination threshold, the anomaly determination unit 65 determines that an anomaly has occurred in just a single weather sensor module 1 (this is an anomaly that requires maintenance).

Furthermore, if the area anomaly determination threshold value is less than F, the anomaly determination unit 65 determines that the anomaly that has occurred was caused by snow that fell in the area, and that the anomaly (area anomaly) is one that can be restored to a normal state over time.

In the example shown in FIG. 12, anomalies have occurred in the sensing values of the rainfall sensors 20 of five of the nine weather sensor modules 1 in the area, so if the weather data for the area for that area acquired from the external service 70 includes information about snowfall, heavy rain, etc., the anomalies in those weather sensor modules 1 are determined to be anomalies that can be restored to a normal state over time.

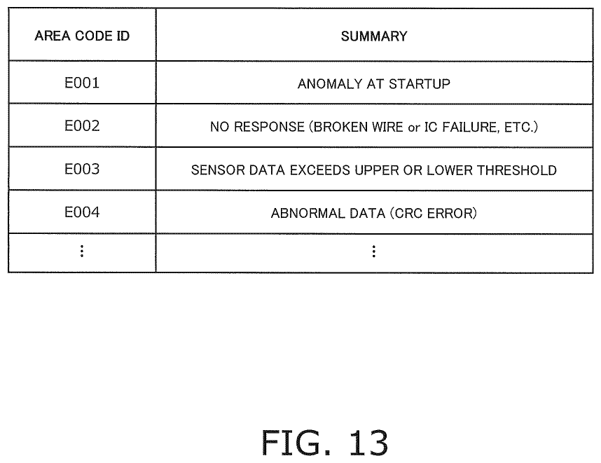

The error codes displayed in FIGS. 11 and 12 are stored in the storage unit 63 as the error code table shown in FIG. 13.

More specifically, the error code ID E001 indicates an anomaly at startup of the weather sensor module 1, the error code ID E002 indicates poor communication with the weather sensor module 1 (disconnection or IC failure), the error code ID E003 indicates that the weather data sensed by the weather sensor module 1 exceeds the upper or lower threshold, and the error code ID E004 indicates an anomaly in the weather data sensed by the weather sensor module 1 (a CRC (cyclic redundancy check) error).

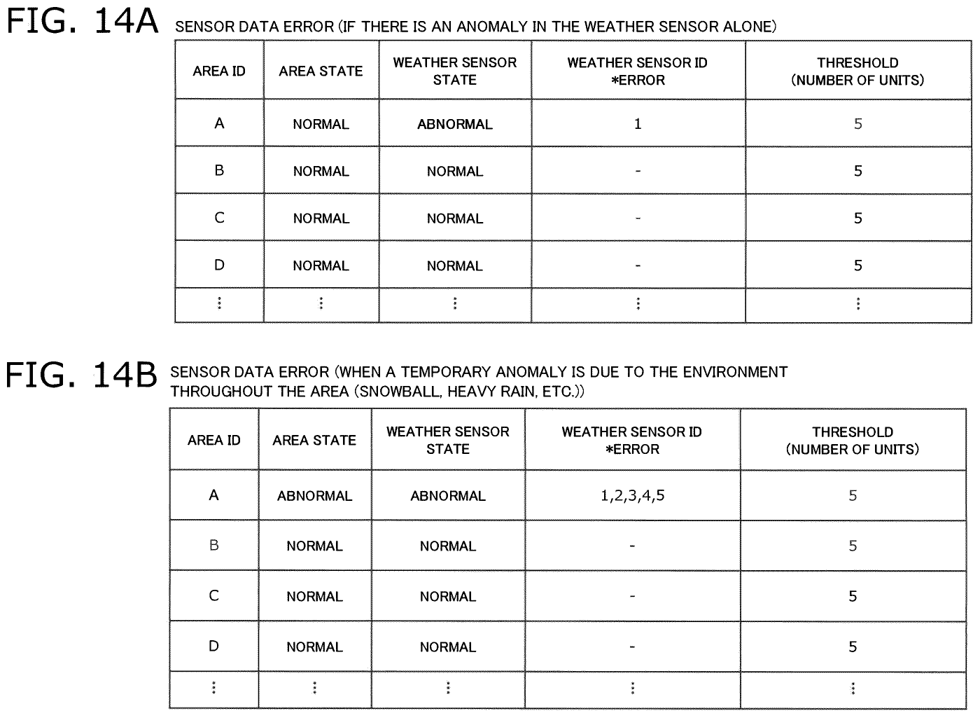

Furthermore, information about the anomaly determination results for the weather sensor modules 1 installed in each of the areas included in the maps shown in FIGS. 8 and 9 is managed for each area A, B, C, and D, as shown in FIGS. 14A and 14B, and is stored in the storage unit 63 of the cloud server 60.

More specifically, for example, if an anomaly occurs in a single weather sensor module 1 in area A, the area status will be displayed as normal and the weather sensor status as abnormal in the area ID: A box, as shown in FIG. 14A, and the weather sensor ID: 1 in which the anomaly occurred will be managed along with the threshold value (number of units) set for each area.

On the other hand, for example, if anomalies have occurred in a number of weather sensor modules 1 in area A, the area status will be displayed as “abnormal” and the weather sensor status will be displayed as “abnormal” in the area ID: A column, as shown in FIG. 14B, and the weather sensor IDs (1, 2, 3, 4, and 5) in which anomalies have occurred will be managed together with the threshold value (number of units) set for each area.

The notification unit 67 notifies the user terminal device 80 (the user) of the determination result obtained by the anomaly determination unit 65. More specifically, the notification unit 67 transmits to the user terminal device 80 information (installation location, type of anomaly, etc.) about the weather sensor modules 1 that require maintenance (or do not require maintenance) among the weather sensor modules 1 in which an anomaly has occurred.

### Method for Determining Anomaly in Weather Sensor Module 1

With the weather sensor system 100 in this embodiment, the cloud server 60 determines whether or not an anomaly that has occurred in a plurality of weather sensor modules 1 is one that can be restored to a normal state over time.

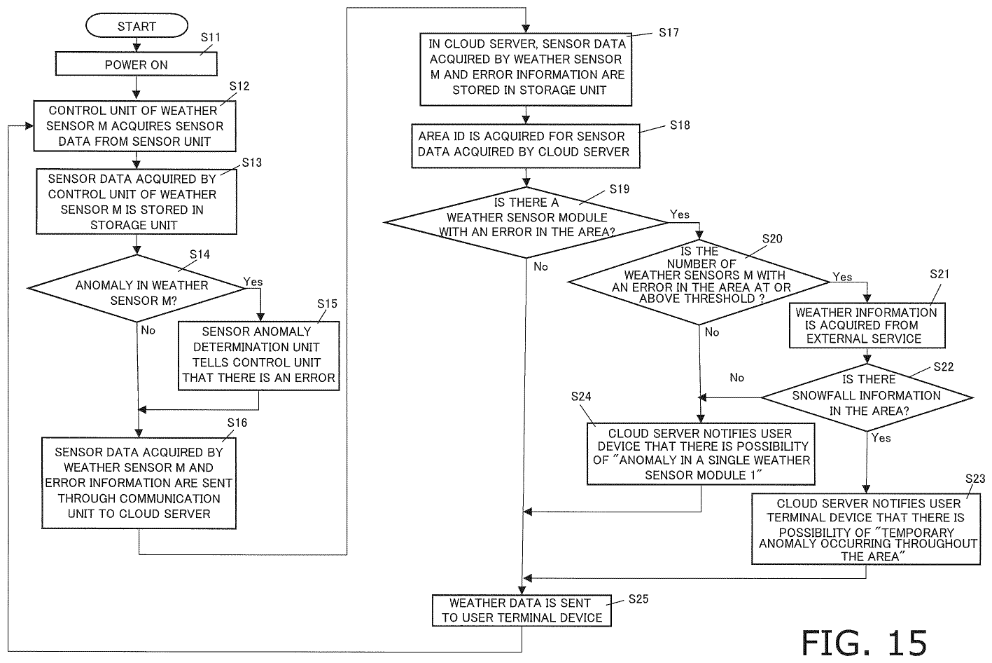

The method for determining an anomaly in a weather sensor module 1 that is executed by the cloud server 60 will now be described with reference to FIG. 15.

When the power supply of the weather sensor module 1 is turned ON in step S11, in step S12 the control unit 50 of the weather sensor module 1 acquires sensor data from each sensor included in the sensor unit 51.

Next, in step S13, the control unit 50 of the weather sensor module 1 stores the sensor data acquired from the sensor unit 51 in the storage unit 52.

Next, in step S14, the sensor anomaly determination unit 53 determines whether or not there is an anomaly in the weather sensor module 1, for example, that the acquired sensor data exceeds a specific threshold value.

If it is determined that there is an anomaly, the processing proceeds to step S15, and if it is determined that there is no anomaly, the processing proceeds to step S16.

Next, in step S15, since it was determined in step S14 that there is an anomaly in the weather sensor module 1, the sensor anomaly determination unit 53 tells the control unit 50 that there is an error (anomaly).

Next, in step S16, the sensor data and error information acquired by the weather sensor module 1 are transmitted through the communication unit 54 to the cloud server 60.

Next, in step S17, the control unit 62 stores in the storage unit 63 the sensor data and error information acquired from the weather sensor module 1 by the data acquisition unit 61 of the cloud server 60.

Next, in step S18, in the cloud server 60, the data acquisition unit 61 acquires the area ID for the area in which the weather sensor module 1 corresponding to the sensor data acquired in step S17 is installed.

Next, in step S19, the anomaly determination unit 65 determines whether or not any of the weather sensor modules 1 installed in the area having the area ID acquired in step S18 has an error (anomaly).

If there is a weather sensor module 1 with an error in the area, the processing proceeds to step S20, and if there is no weather sensor module 1 with an error in the area, the processing proceeds to step S25.

Next, in step S20, since it was determined in step S19 that there is a weather sensor module 1 with an error in the area, the threshold determination unit 64 determines whether the number of weather sensor modules 1 with an error in the area is at or above a specific threshold.

If the number of weather sensor modules 1 with an error in the area is at or above the specific threshold, the processing proceeds to step S21. If the number is below the specific threshold, the processing proceeds to step S24.

Next, in step S21, since it was determined in step S20 that the number of weather sensor modules 1 with an error in the area is equal to or greater than a specific number, the data acquisition unit 61 acquires meteorological information for the geographical region including that area (such as information about snowfall, heavy rain, etc.) from the external service 70.

Next, in step S22, it is determined whether or not snowfall information is included in the meteorological information acquired in step S21. If snowfall information is included, the processing proceeds to step S23, and otherwise the processing proceeds to step S24.

Next, in step S23, since it was determined in step S22 that the meteorological information obtained in step S21 includes snowfall information, the notification unit 67 of the cloud server 60 notifies the user terminal device 80 that there is a possibility that a “temporary anomaly occurring throughout the area” (an anomaly that does not require maintenance) has occurred.

On the other hand, in step S24, since it was determined in step S20 that the number of weather sensor modules 1 with an error in the area is not greater than a specific number, or since it was determined in step S22 that there is no snowfall information in the area, the notification unit 67 of the cloud server 60 notifies the user terminal device 80 that there is a possibility that an “anomaly in a single weather sensor module 1” (an anomaly that requires maintenance) has occurred.

The notification content in steps S23 and S24 may be displayed on the display unit 66 of the cloud server 60.

Next, in step S25, the weather data is conveyed to the user terminal device 80, and the processing returns to step S12.

### Main Features

The cloud server 60 that determines whether or not an anomaly has occurred in a weather sensor module 1 of this embodiment includes the data acquisition unit 61 and the anomaly determination unit 65, as shown in FIG. 1. The data acquisition unit 61 acquires, from the weather sensor module 1, weather data sensed by the weather sensor module 1 and anomaly determination data that determines whether or not an anomaly has occurred in the weather sensor module 1. The data acquisition unit 61 externally acquires weather data for the location where the weather sensor module 1 is installed. The anomaly determination unit 65 determines whether or not an anomaly can be restored to a normal state over time on the basis of whether there is an anomaly for each weather sensor module 1 in a specific area where a plurality of weather sensor modules 1 have been installed, as acquired by the data acquisition unit 61, and the weather data acquired by the data acquisition unit 61.

Consequently, even if a temporary anomaly should occur in a weather sensor module 1 due to snowfall or heavy rain, for example, it can be determined whether the anomaly is one that can be restored to a normal state over time, which means there is no need to dispatch maintenance personnel to the installation site.

As a result, whether or not a sensed anomaly in a weather sensor module 1 is one that will require maintenance can be ascertained, so need to dispatch maintenance personnel to the installation site can be kept to a minimum.

### Embodiment 2

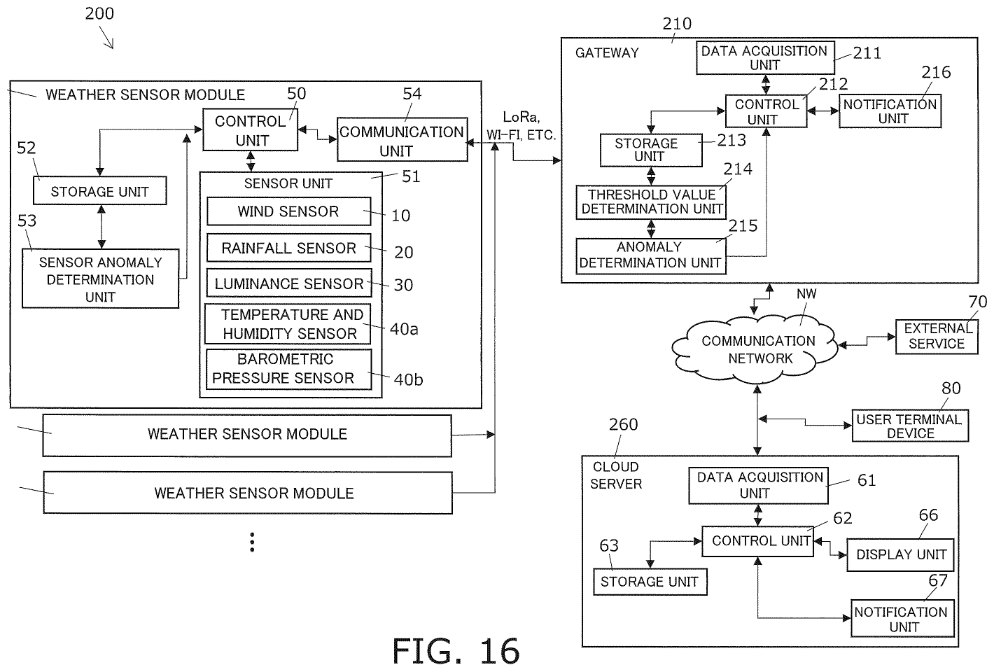

A gateway (weather sensor anomaly determination device) 210 that performs anomaly determination for a weather sensor module (weather sensor) 1 according to another embodiment of the present invention, and a weather sensor system 200 equipped with this gateway will now be described with reference to FIGS. 16 to 18.

In the configuration shown in FIG. 16, components having the same functions as those in the first embodiment shall be numbered the same, and shall not be described again in detail.

In Embodiment 1 above, an example was given in which the cloud server 60 was the entity that determines whether or not an anomaly that had occurred in each weather sensor module 1 was an anomaly that could be restored to a normal state over time.

With the weather sensor system 200 of this embodiment, as shown in FIG. 16, the gateway (weather sensor anomaly determination device) 210 that is connected to a plurality of weather sensor modules 1 via communication lines such as LoRa or Wi-Fi (registered trademark) functions as an entity that determines whether or not an anomaly that occurs in a weather sensor module 1 is one that can be restored to a normal state over time.

With the weather sensor system 200, as shown in FIG. 16, the gateway 210 includes a data acquisition unit 211, a control unit 212, a storage unit 213, a threshold determination unit 214, an anomaly determination unit 215, and a notification unit 216.

As shown in FIG. 16, the cloud server 260 includes a data acquisition unit 61, a control unit 62, a storage unit 63, a display unit 66, and a notification unit 67. That is, in this embodiment, the cloud server 260 differs from the configuration described in the Embodiment 1 above in that it does not include a component that performs anomaly determination.

The data acquisition unit (data acquisition unit, external data acquisition unit) 211 acquires, from a weather sensor module 1, weather data sensed by the weather sensor module 1, and anomaly determination data that determines whether there is an anomaly in the weather sensor module 1. The data acquisition unit 211 acquires weather data for the location where the weather sensor module 1 is installed, from the external service 70. The data acquisition unit 61 also functions as an external data acquisition unit, and acquires snowfall information as weather data.

The control unit 212 is constituted by a CPU (central processing unit) and other circuits, and is connected to and controls the data acquisition unit 211, the storage unit 213, the anomaly determination unit 215, and the notification unit 216.

The storage unit 213 stores the weather data and anomaly determination data acquired by the data acquisition unit 211, and the weather data acquired by the data acquisition unit 211 from the external service 70.

The weather data sensed by the weather sensor module 1 and stored in the storage unit 213 includes, for example, the sensed time, the weather sensor module ID (identification) assigned to each multiple weather sensor module 1, temperature (C), humidity (% RH), luminance (lux), wind speed (m/s), wind direction) (°, rainfall (mm/h), and barometric pressure (hPa).

The storage unit 213 also stores the installation location (latitude and longitude), altitude (m), installation location information (plains, mountains, etc.), and an area ID indicating in which area the module is installed, which is set in advance to a range such as a city, town, or region.

The threshold determination unit 214 determines whether the number of weather sensor modules 1 with an error (abnormal) in an area is at or above a specific threshold. That is, the threshold determination unit 214 determines whether, out of all the weather sensor modules 1 installed in a specific area, a number at or above a specific threshold are simultaneously in an error state.

The anomaly determination unit 215 determines whether there is an anomaly for each weather sensor module 1 in a specific area in which a plurality of weather sensor modules 1 have been installed, as acquired by the data acquisition unit 211, and, on the basis of the weather data acquired by the data acquisition unit 211 from the external service 70, whether or not the anomaly can be restored to a normal state over time.

In particular, the anomaly determination unit 215 uses the snowfall information acquired by the data acquisition unit 211 to determine whether or not a weather sensor module 1 is experiencing an anomaly that can be eliminated over time.

The anomaly determination unit 215 refers to weather data (information about snowfall, heavy rain, etc.) acquired from the external service 70, and if the number of weather sensor modules 1 determined to have experienced an anomaly in a specified area exceeds a specific threshold, it is determined that these anomalies are not anomalies that require maintenance, but are caused by snowfall, etc., that can be eliminated over time.

The specific area subject to anomaly determination for the weather sensor module 1 is set in advance to include a plurality of weather sensor modules 1.

The notification unit 216 notifies the user terminal device 80 (the user) on the basis of the determination result by the anomaly determination unit 215. More specifically, the notification unit 216 transmits to the user terminal device 80 information (installation location, type of anomaly, etc.) about the weather sensor modules 1 that require maintenance (or do not require maintenance) among the weather sensor modules 1 in which an anomaly has occurred.

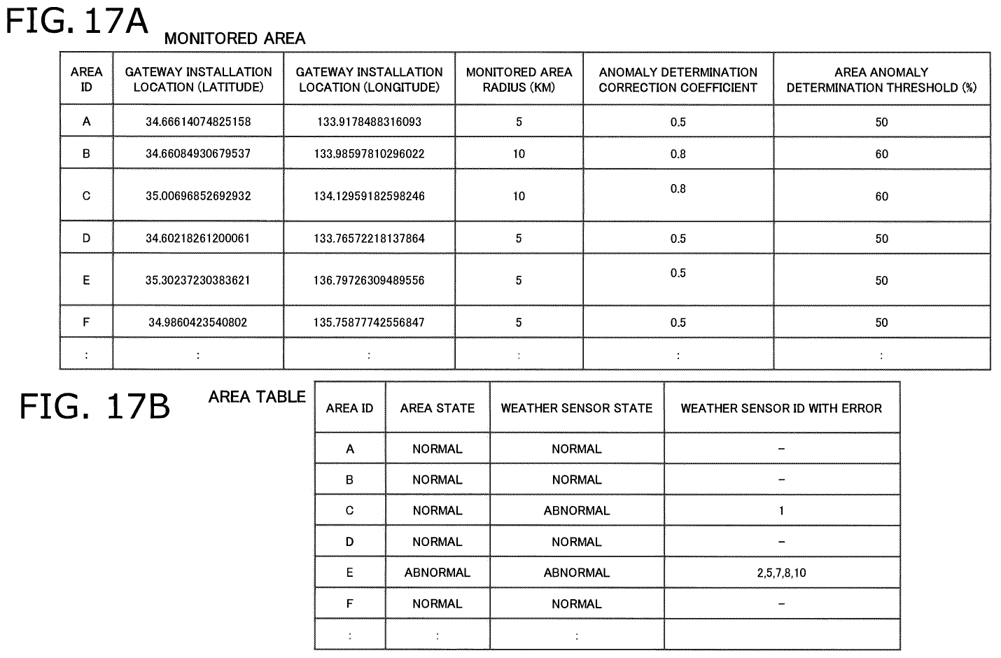

In this embodiment, the storage unit 213 stores information related to the monitoring area shown in FIG. 17A.

More specifically, as shown in FIG. 17A, the area ID, the installation location (latitude and longitude) of the gateway 210, the monitoring area radius (m), a correction coefficient for anomaly determination, and the area anomaly determination threshold value (%) are stored as management area information.

Information about the installation position (latitude and longitude) of the gateway 210 is used to set the area, together with the radius of the monitoring area, for example. This allows the gateway 210 to handle area setting by the cloud server 260, thereby simplifying the system of the cloud server 260.

The determination results from the anomaly determination unit 215 of the gateway 210 are then stored in the storage unit 213 as the area ID, area status (normal or abnormal), weather sensor status (normal or abnormal), and ID (1 to 10) for the weather sensors that are in error, as shown in FIG. 17B.

For example, in area C shown in FIG. 17B, the area state is determined to be normal and the weather sensor state abnormal, so it can be seen that the anomaly occurring in the weather sensor module 1 in area C is an anomaly in a single weather sensor module 1 (a disconnected wire, IC failure, etc.), is not related to the weather, and is an anomaly that requires maintenance.

On the other hand, in area E shown in FIG. 17B, the area state is determined to be abnormal and the weather sensor state also abnormal, so for an anomaly in the weather sensor module 1 occurring in area E, the user refers to meteorological information, and if this includes snowfall information, it can be seen that this is not an anomaly in a single weather sensor module 1, but a temporary anomaly caused by the effects of snowfall in that area (an anomaly that may return to a normal state over time).

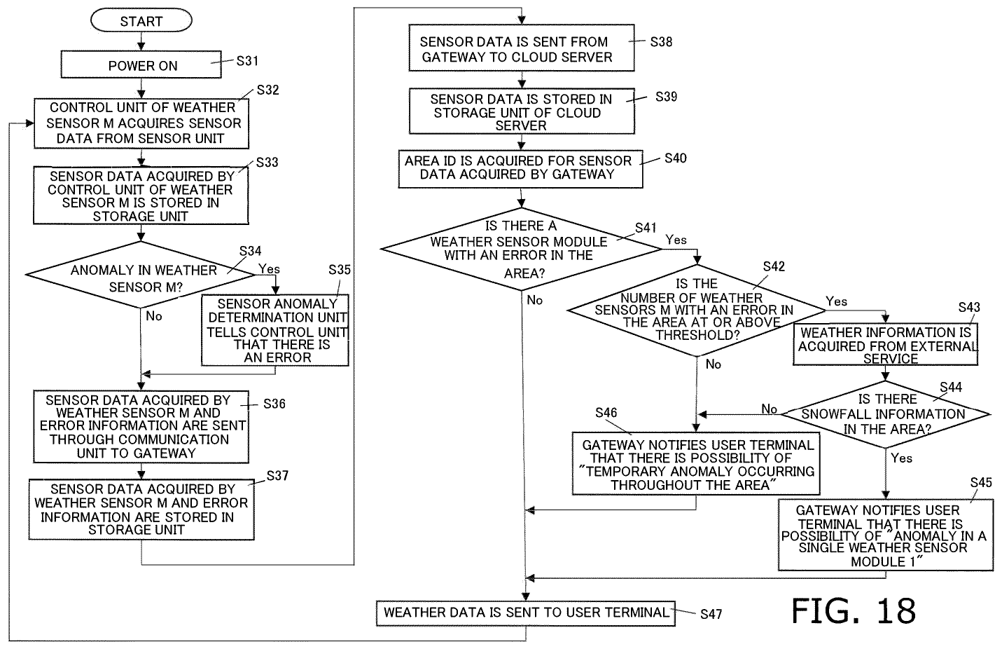

With the weather sensor system 200 shown in FIG. 16, an anomaly determination process is carried out according to the flowchart shown in FIG. 18.

That is, in steps S31 to S35, the same processing is performed as in steps S11 to S15 in the flowchart of FIG. 15 in Embodiment 1 above.

Next, in step S36, the sensor data and error information acquired by the weather sensor module 1 are transmitted to the gateway 210 via the communication unit 54.

Next, in step S37, the control unit 212 stores in the storage unit 213 the sensor data and error information acquired from the weather sensor module 1 by the data acquisition unit 211 of the gateway 210.

Next, in step S38, the notification unit 216 of the gateway 210 transmits the sensor data to the cloud server 60 on a communication network NW.

Next, in step S39, the control unit 62 of the cloud server 60 stores the sensor data acquired by the data acquisition unit 61 in the storage unit 63.

Next, in step S40, in the gateway 210, the data acquisition unit 211 acquires the area ID for the area in which the weather sensor module 1 corresponding to the sensor data acquired in step S39 is installed.

Next, in step S41, the anomaly determination unit 215 determines whether or not any of the weather sensor modules 1 installed in the area having the area ID acquired in step S40 has an error (anomaly).

Here, if there is a weather sensor module 1 with an error in the area, the processing proceeds to step S42, but if there is no weather sensor module 1 with an error in the area, the processing proceeds to step S47.

Next, in step S42, since it was determined in step S41 that there is a weather sensor module 1 with an error in the area, the threshold determination unit 214 determines whether the number of weather sensor modules 1 with an error in the area is at or above a specific threshold.

If the number of weather sensor modules 1 with an error in the area is at or above the specific threshold, the processing proceeds to step S43, but if it is below the specific threshold, the processing proceeds to step S46.

Next, in step S43, since it was determined in step S42 that the number of weather sensor modules 1 with an error in the area is equal to or greater than a specific number, the data acquisition unit 211 acquires meteorological information for the geographical region including that area (such as information about snowfall, heavy rain, etc.) from the external service 70.

Next, in step S44, it is determined whether or not the meteorological information acquired in step S43 includes snowfall information. If snowfall information is included, the processing proceeds to step S45, and otherwise the processing proceeds to step S46.

Next, in step S45, since it was determined in step S44 that the meteorological information acquired in step S43 includes snowfall information, the notification unit 216 of the gateway 210 notifies the user terminal device 80 that there is a possibility that a “temporary anomaly occurring throughout the entire area” (an anomaly that does not require maintenance) has occurred.

On the other hand, in step S46, since it was determined in step S42 that the number of weather sensor modules 1 with an error in the area is not greater than a specific number, or since it was determined in step S44 that there is no snowfall information for the area, the notification unit 216 of the gateway 210 notifies the user terminal device 80 that there is a possibility that an “anomaly in a single weather sensor module 1” (an anomaly that requires maintenance) has occurred.

Next, in step S47, the weather data is sent to the user terminal device 80, and the processing returns to step S32.

### OTHER EMBODIMENTS

An embodiment of the present invention was given above, but the present invention is not limited to or by the above embodiment, and various modifications are possible without departing from the gist of the invention.

### (A)

In the above embodiment, an example was given in which the present invention was realized as a weather sensor anomaly determination device and an anomaly determination method for a weather sensor, but the present invention is not limited to this.

For example, the present invention may be realized as an anomaly determination program that causes a computer to execute the above-mentioned weather sensor anomaly determination method.

This weather sensor anomaly determination program is stored in a memory (storage unit) installed in a weather sensor anomaly determination device, and the CPU reads the anomaly determination program stored in the memory and causes the hardware to execute the steps. More specifically, the CPU reads the anomaly determination program and executes the steps described above, thereby achieving the same effect as described above.

Also, the present invention may be realized as a recording medium that stores a weather sensor anomaly determination program.

### (B)

In the above embodiment, an example was given in which an area indicated by a circle was set in advance within the range of a city, town, region, etc., in which the weather sensor modules 1 were installed, as shown in FIG. 8. However, the present invention is not limited to this.

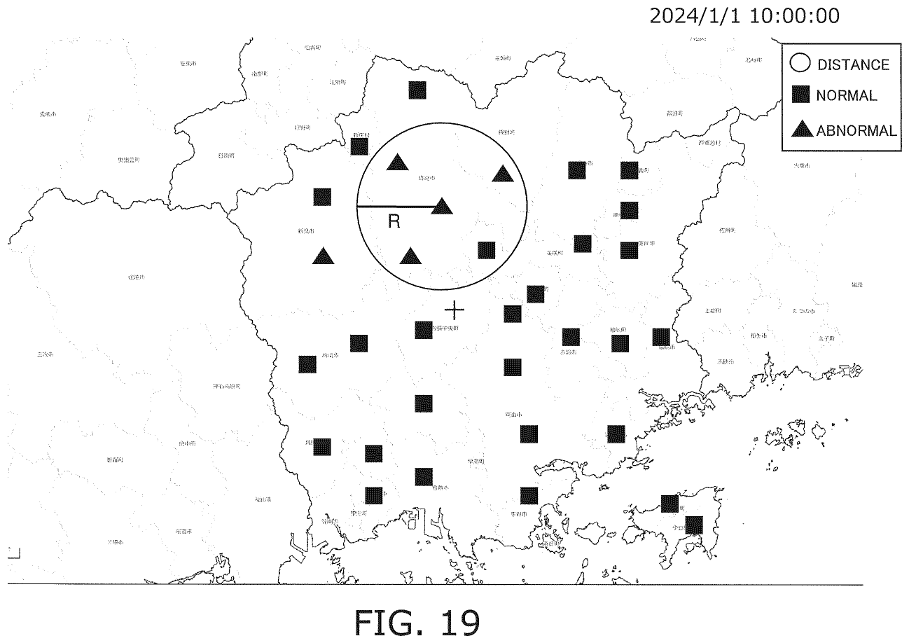

For example, as shown in FIG. 19, the configuration may be such that a circular range with a radius R (km) centered on the position of a reference weather sensor module 1 among the weather sensor modules 1 in which an anomaly has occurred is set as the determination area.

In this case, in step S18 of the flowchart shown in FIG. 15, “the position of the weather sensor module 1 that sensed the sensor data acquired by the cloud server 60 is acquired,” and in step S19, it is determined “whether or not there is a weather sensor module 1 with an error in an area that is within a certain distance from the position acquired by the cloud server 60.”

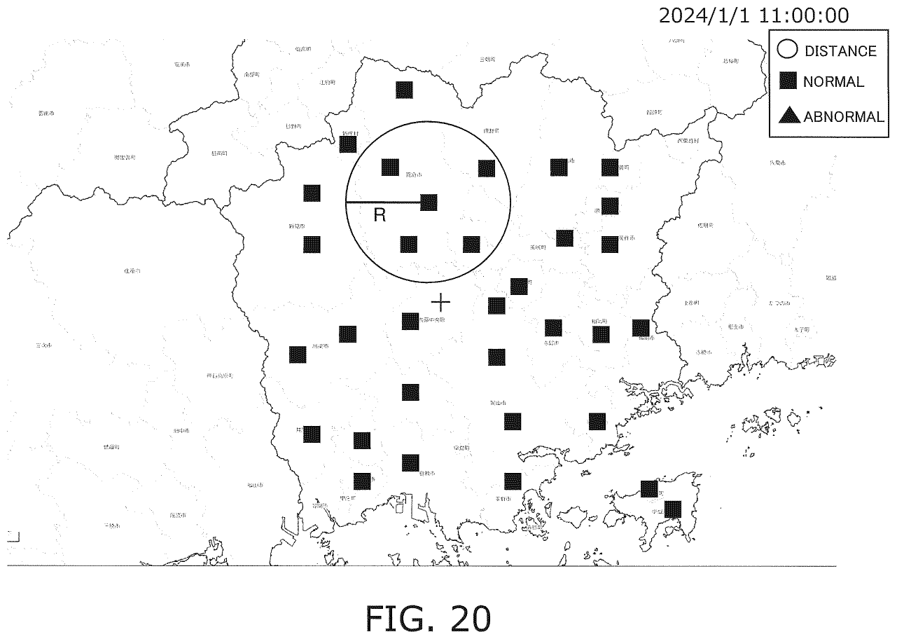

As shown in FIG. 19, for a plurality of weather sensor modules 1 (▴) within an area that are determined to be experiencing an anomaly, if the sensor units 51 (such as the rain sensors 20) are unable to sense due to snowfall or heavy rain, for example, as the snow melts over time or the heavy rain stops, the weather sensor modules 1 within an area of radius R (km) will return to a normal state (▪), as shown in FIG. 20.

Consequently, the anomaly determination unit 65 or 215 can determine that the anomalies in a plurality of weather sensor modules 1 that have been determined to have had an anomaly within the area shown in FIGS. 19 and 20 are anomalies that can be restored to a normal state over time, thereby minimizing the dispatch of maintenance personnel.

### (C)

In the above embodiment, an example was given in which snowfall information was used to determine whether or not the anomaly in the weather sensor module 1 could be restored to a normal state over time (area anomaly). However, the present invention is not limited to this.

For example, meteorological information such as localized heavy rain, hail, or sleet in the area where the linear precipitation band occurred may be used to determine whether or not the anomaly is one that can be restored to a normal state over time (area anomaly).

### (D)

In the above embodiment, an example was given in which the data acquisition unit 61 or 211 acquired sensed weather data and anomaly determination data from the weather sensor module 1, and also acquired meteorological information for the area in which the weather sensor module 1 was installed from an external service 70 that provided meteorological information. However, the present invention is not limited to this.

For example, a data acquisition unit that acquires weather data and anomaly determination data sensed by a weather sensor, and an external data acquisition unit that acquires meteorological information from an external service may be provided separately.

### (E)

In the above embodiment, an example was given in which the amount of rainfall, wind (wind speed and direction), temperature, humidity, and atmospheric pressure were sensed as meteorological data in the weather sensor module 1. However, the present invention is not limited to this.

For example, the weather sensor may sense only some of the above-mentioned weather data, or may sense weather data other than what was mentioned above.

### (F)

In the above embodiment, an example was given in which whether or not an anomaly could be restored to a normal state over time (area anomaly) was determined on the basis of whether or not the number of weather sensor modules 1 in which an anomaly had occurred was at or above a specific threshold relative to the total number of weather sensor modules 1 installed in the area. However, the present invention is not limited to this.

For example, rather than determining the number of weather sensors in an area that have experienced anomalies, the system may refer to meteorological information such as snowfall in the area acquired from the external source, and determine whether the anomaly is one that can be restored to a normal state over time (area anomaly).

### (G)

In the above embodiment, an example was given in which weather data for each region was sensed using a weather sensor module 1 having the structure shown in FIGS. 2 to 5. However, the present invention is not limited to this.

The structure, shape, and function of the weather sensor are not limited to what was described in the above embodiment, and various kinds of weather sensors can be used.

### Additions

A weather sensor anomaly determination device according to the first invention 1 for determining whether or not an anomaly has occurred in a weather sensor, the weather sensor anomaly determination device comprising:
a data acquisition unit configured to acquire from the weather sensor weather data sensed by the weather sensor and anomaly determination data that determines whether or not there is any anomaly in the weather sensor;
an external data acquisition unit configured to acquire weather data at a location where the weather sensor is installed from an external source; and
an anomaly determination unit configured to determine whether or not an anomaly can be eliminated to restore a normal state over time on the basis of whether any anomaly has been acquired by the data acquisition unit for each of the multiple weather sensors in a specific area in which the weather sensors have been installed, and the weather data acquired by the external data acquisition unit.

The weather sensor anomaly determination device according to the second invention is the weather sensor anomaly determination device according to the first invention, wherein the external data acquisition unit acquires snowfall information as the weather data.

The weather sensor anomaly determination device according to the third invention is the weather sensor anomaly determination device according to the second invention, wherein the anomaly determination unit uses the snowfall information acquired by the external data acquisition unit to determine whether or not there is any anomaly in the weather sensor that can be eliminated over time.

The weather sensor anomaly determination device according to the fourth invention is the weather sensor anomaly determination device according to any of the first to third invention, wherein the anomaly determination unit determines that the anomaly can be eliminated over time if a number of the weather sensors in the specific area for which it has been determined that an anomaly has occurred exceeds a specific threshold.

The weather sensor anomaly determination device according to the fifth invention is the weather sensor anomaly determination device according to any of the first to fourth invention,
wherein the anomaly determination data includes either no response, weather data exceeding an upper threshold or a lower threshold, or abnormal data.

The weather sensor anomaly determination device according to the sixth invention is the weather sensor anomaly determination device according to any of the first to fifth invention,
wherein the specific area is preset so as to include a plurality of the weather sensors.

The weather sensor anomaly determination device according to the seventh invention is the weather sensor anomaly determination device according to any of the first to sixth invention,
wherein the specific area is set within a specific range of distance centered on a reference weather sensor that serves as a reference among the plurality of weather sensors.

The weather sensor anomaly determination device according to the eighth invention is the weather sensor anomaly determination device according to any of the first to seventh invention,
wherein the data acquisition unit acquires data about at least one of temperature, humidity, luminance, wind speed, wind direction, rainfall, and atmospheric pressure.

The weather sensor anomaly determination device according to the ninth invention is the weather sensor anomaly determination device according to any of the first to eighth invention, further comprising
a storage unit configured to store weather data and anomaly determination data acquired by the data acquisition unit and the weather data acquired by the external data acquisition unit.

The weather sensor anomaly determination device according to the tenth invention is the weather sensor anomaly determination device according to any of the first to ninth invention, further comprising
a display unit configured to display a determination result of the anomaly determination unit.

The weather sensor anomaly determination device according to the eleventh invention is the weather sensor anomaly determination device according to any of the first to tenth invention, further comprising
a notification unit configured to notify a user on the basis of a determination result of the anomaly determination unit.

A weather sensor system according to the twelfth invention, comprising:
the weather sensor anomaly determination device according to any of the first to eleventh invention, and
a plurality of the weather sensors.

### INDUSTRIAL APPLICABILITY

The weather sensor anomaly determination device of the present invention exhibits the effect that it can be determined whether or not an anomaly can be eliminated over time and restored to a normal state, and therefore is widely applicable to a variety of systems, such as weather sensor systems that manage weather sensors and agricultural monitoring systems.

### REFERENCE SIGNS LIST

1 weather sensor module (weather sensor)
10 wind sensor
11a, 11b, 11c, 11d ultrasonic sensors
12 base
12a upper surface
13 reflective surface
14 post
15 base portion
20 rainfall sensor
21 housing unit
21a opening
21b inner wall surface
22a light source unit
22b light receiving unit
23 leg
24 base
30 luminance sensor
40a temperature and humidity sensor
40b barometric pressure sensor
50 control unit
51 sensor unit
52 storage unit
53 sensor anomaly determination unit
54 communication unit
60 cloud server (weather sensor anomaly determination device)
61 data acquisition unit (data acquisition unit, external data acquisition unit)
62 control unit
63 storage unit
64 threshold value determination unit
65 anomaly determination unit
66 display unit
67 notification unit
70 external service (external)
80 user terminal device
100 weather sensor system
200 weather sensor system
210 gateway (weather sensor anomaly determination device)
211 data acquisition unit (data acquisition unit, external data acquisition unit)
212 control unit
213 storage unit
214 threshold value determination unit
215 anomaly determination unit
216 notification unit
NW communication network

What is claimed is:

1. A weather sensor anomaly determination device for determining whether or not an anomaly has occurred in a weather sensor, the weather sensor anomaly determination device comprising:
a data acquisition unit configured to acquire from the weather sensor weather data sensed by the weather sensor and anomaly determination data that determines whether or not there is any anomaly in the weather sensor;
an external data acquisition unit configured to acquire weather data at a location where the weather sensor is installed from an external source; and
an anomaly determination unit configured to determine whether or not an anomaly can be eliminated to restore a normal state over time on the basis of whether any anomaly has been acquired by the data acquisition unit for each of the multiple weather sensors in a specific area in which the weather sensors have been installed, and the weather data acquired by the external data acquisition unit.

2. The weather sensor anomaly determination device according to claim 1,
wherein the external data acquisition unit acquires snowfall information as the weather data.

3. The weather sensor anomaly determination device according to claim 2,
wherein the anomaly determination unit uses the snowfall information acquired by the external data acquisition unit to determine whether or not there is any anomaly in the weather sensor that can be eliminated over time.

4. The weather sensor anomaly determination device according to claim 1,
wherein the anomaly determination unit determines that the anomaly can be eliminated over time if a number of the weather sensors in the specific area for which it has been determined that an anomaly has occurred exceeds a specific threshold.

5. The weather sensor anomaly determination device according to claim 1,
wherein the anomaly determination data includes either no response, weather data exceeding an upper threshold or a lower threshold, or abnormal data.

6. The weather sensor anomaly determination device according to claim 1,
wherein the specific area is preset so as to include a plurality of the weather sensors.

7. The weather sensor anomaly determination device according to claim 1,
wherein the specific area is set within a specific range of distance centered on a reference weather sensor that serves as a reference among the plurality of weather sensors.

8. The weather sensor anomaly determination device according to claim 1,
wherein the data acquisition unit acquires data about at least one of temperature, humidity, luminance, wind speed, wind direction, rainfall, and atmospheric pressure.

9. The weather sensor anomaly determination device according to claim 1,
further comprising a storage unit configured to store weather data and anomaly determination data acquired by the data acquisition unit and the weather data acquired by the external data acquisition unit.

10. The weather sensor anomaly determination device according to claim 1,
further comprising a display unit configured to display a determination result of the anomaly determination unit.

11. The weather sensor anomaly determination device according to claim 1,
further comprising a notification unit configured to notify a user on the basis of a determination result of the anomaly determination unit.

12. A weather sensor system, comprising:
the weather sensor anomaly determination device according to claim 1; and
a plurality of the weather sensors.

13. An anomaly determination method for determining whether or not any anomaly has occurred in a weather sensor, comprising:
a data acquisition step of acquiring, from the weather sensor, weather data sensed by the weather sensor and anomaly determination data that determines whether or not there is any anomaly in the weather sensor;
an external data acquisition step of acquiring weather data at a location where the weather sensor is installed from an external source; and
an anomaly determination step of determining whether or not an anomaly can be eliminated to restore a normal state over time on the basis of whether any anomaly has been acquired in the data acquisition step for each of the multiple weather sensors in a specific area in which the weather sensors have been installed, and the weather data acquired in the external data acquisition step.

14. An anomaly determination program that determines whether or not an anomaly has occurred in a weather sensor, the anomaly determination program causing a computer to execute an anomaly determination method for determining whether or not any anomaly has occurred in a weather sensor, the method comprising:
a data acquisition step of acquiring, from the weather sensor, weather data sensed by the weather sensor and anomaly determination data that determines whether or not there is any anomaly in the weather sensor;
an external data acquisition step of acquiring weather data at a location where the weather sensor is installed from an external source; and
an anomaly determination step of determining whether or not an anomaly can be eliminated to restore a normal state over time on the basis of whether any anomaly has been acquired in the data acquisition step for each of the multiple weather sensors in a specific area in which the weather sensors have been installed, and the weather data acquired in the external data acquisition step.
